(19) United States
(12) Patent Application Publication
(10) Pub. No.: US 2008/0123835 A1
(43) Pub. Date: May 29, 2008

(54) System and method for providing toll free or reduced fee international calling

(75) Inventor: Anthony H. Fischler, Santa Monica, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Hoi Polloi, Inc.

(21) Appl. No.: 11/606,835

(22) Filed: Nov. 29, 2006

(51) Int. Cl. H04M 7/00

(52) U.S. Cl. 379/221.02

(57) ABSTRACT

A system includes a local exchange carrier that operates to receive telephone calls from carriers, a platform that operates to receive the telephone calls from the local exchange carrier and selected international carriers to receive the telephone calls from the platform. The selected international carriers are selected so that termination fees of the selected international carriers are either less than or equal to fees received by a provider of the platform from the local exchange carrier. A method includes selecting a local exchange contractor, providing a platform to forward telephone calls received by the local exchange contractor, and selecting many international carriers. The international carriers are selected based on international termination fees being less than fees received by a platform provider from the local exchange carrier.

### BACKGROUND OF THE INVENTION

1. Field of the Invention

Exemplary embodiments relate generally to the technical field of providing international telephone service and, in one exemplary embodiment, to methods and systems to provide international toll free or reduced fee telephone service.

2. Description of the Related Art

International telephone calls made from a land line telephone device or a cellular telephone are routed through a U.S. carrier and are forwarded to an international carrier for a cost, which is typically very expensive. Due to the costs of international telephone service, many people do not communicate via a telephone device for international calls or do so very infrequently.

### SUMMARY

In one embodiment a system includes a local exchange carrier that operates to receive telephone calls from many carriers. A platform operates to receive the telephone calls from the local exchange carrier and terminate those calls to selected international carriers. The selected international carriers are selected so that termination fees of the selected international carriers are either less than or equal to fees received by a provider of the platform from the local exchange carrier.

In another embodiment a method includes selecting a local exchange contractor, providing a platform to forward telephone calls received by the local exchange contractor, and selecting many international carriers. The international carriers are selected based on international termination fees being less than fees received by a platform provider from the local exchange carrier.

In still another embodiment a method includes placing a call to a telephone number associated with a selected local exchange carrier, requesting an end user to enter an international telephone number by a platform, and forwarding the call to the international telephone number. The end user is not charged an international calling fee.

In yet another embodiment a system includes a first device used by a first user to place a telephone call through a domestic carrier, a local exchange carrier that operates to receive the telephone call from the domestic carrier, and a platform that operates to place an international telephone call to connect the first device to a second device used by a second user. Many selected international carriers are selected so that termination fees of the selected international carriers are either less than or equal to fees received by a provider of the platform from the local exchange carrier.

### BRIEF DESCRIPTION OF THE DRAWINGS

Embodiments are illustrated by way of example and not by way of limitation in the figures of the accompanying drawings in which like references indicate similar elements. It should be noted that references to “an” embodiment in this disclosure are not necessarily to the same embodiment, and such a reference may mean at least one.

FIG. 1 illustrates call and fee flow in a system of an embodiment.

FIG. 2 illustrates a block diagram of a calling process.

FIG. 3 illustrates fee payment flow.

FIG. 4 illustrates a process for selecting routing entities for an embodiment.

FIG. 5 illustrates an embodiment of a website page offering free international telephone calls.

### DETAILED DESCRIPTION

A method and system to provide toll free or reduced fee international telephone service to users for a profit are described. In the following description, for purposes of explanation, numerous specific details are set forth in order to provide a thorough understanding of an exemplary embodiment of the present invention. It will be evident, however, to one skilled in the art that the present invention may be practiced without these specific details.

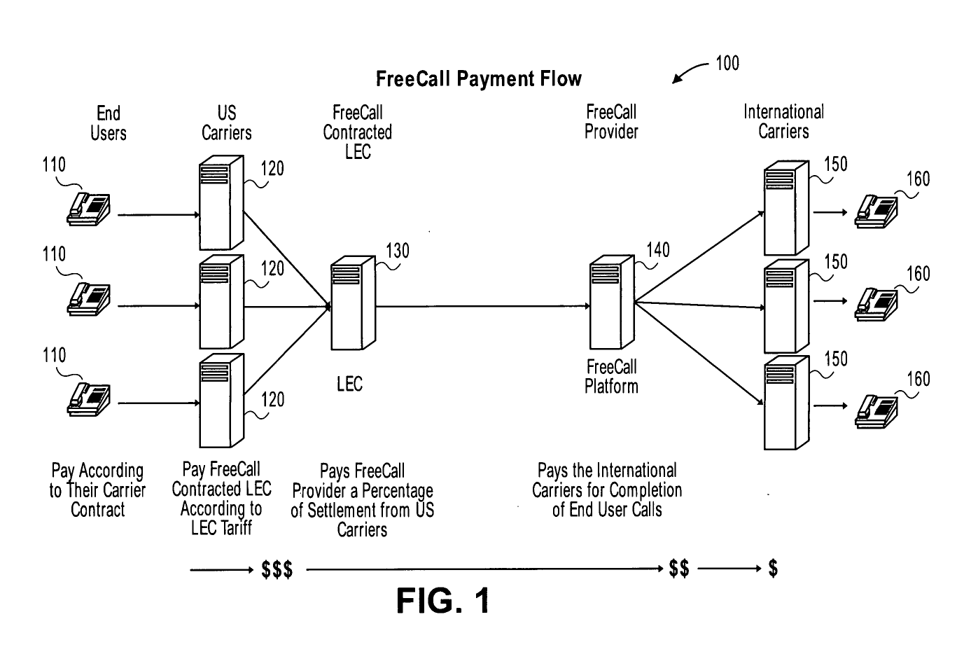

FIG. 1 is a diagram depicting a system 100, according to one exemplary embodiment. End users 110 use any device capable of making/receiving a telephone call. End users 100 devices can be land line based telephones, cellular telephones, facsimile machines, etc. End users 110 make calls through their contracted U.S. carrier or telephone service 120. End users 110 pay the specified fee to their respective carrier or telephone service provider. Many carriers 120 have plans that end users 110 can sign up for that give them free minutes (e.g., between certain hours of the day, weekends, etc.) for long distance telephone calls. Other U.S. carriers 120 offer plans of a limited number of long distance minutes for a monthly fee. Other carriers 120 may offer unlimited long distance service for a flat monthly fee. End users 110 that make telephone calls outside of a plan or free minutes time are charged their respective rates for the respective carrier 120. End users 110 that are geographically located in the same area code as a contracted local exchange carrier (LEC) in the U.S. that provides local service simply make a local call and are charged by the carrier 120 at their respective fee, if any.

A telephone call made by end user 110 is routed through carrier 120 to a contracted LEC 130. LEC 130 has a set fee or tariff that carrier 120 pays for receiving services. LEC 130 routes a call made by end users 110 to platform 140. LEC 130 pays platform 140 a percentage of settlement fees from carrier 120. Platform 140 forwards a call made by end user to international carrier 150. International carriers 150 complete the call to the destination receiving user 160. Platform 140 pays a fee to international carrier 150 for completion of a call made by end users 110.

In one embodiment, LEC 130 is selected based on the tariff or fee that LEC 130 charges carriers 120 for termination to the access number. In this embodiment, international calls are directed to countries where international carriers 150 charge platform 140 a reduced fee. In this embodiment, LEC 130 receives a fee from carriers 120 and pays a percentage of this fee to platform 140, which in turn pays a percentage of the fee received from LEC 120 to international carriers 150. Therefore, an end user having free minutes, a set plan, etc. places a call to a telephone number that carrier 120 forwards to LEC 130. LEC 130 forwards the call to platform 140. End user 110 is prompted by platform 140 to enter the country code and telephone number of receiving user 160. Platform 140 contracts with selected international carriers 150 at a desired fee per minute that is less than the percentage platform 140 receives from LEC 130. For example, carrier 120 may pay a fee or tariff to LEC 130 of $0.03 per minute. LEC 130 may pay platform 140 $0.01-$0.02 per minute. And platform 140 may pay international carrier 150 $0.009 per minute. The owner of platform 140, for providing telephone calls to international numbers at a discounted or toll free rate, for contracting with LEC 130, and selecting specific countries makes a profit. This is the case even if carriers 120 are providing free calls to end users 110.

In one embodiment end users 110 can make international calls through the platform 140 provider without ever making any direct payments to the platform 140 provider. In this embodiment platform 140 only provides termination to international locations where the wholesale cost is lower than the compensation earned from the contracted LEC 130.

In another embodiment the cost of international termination is offset without limiting calling to the lowest cost countries. Instead, the platform 140 provider can use the compensation from the contracted LEC 130 to offset its costs and offer lower priced international calling world wide to end users 110. In this case the platform 140 provider must collect payment from the consumer.

In yet another embodiment, advertising can be played to end users 110 where the advertisers pay a fee to the platform 140 provider. In still another embodiment, receiving user 160 can also be played an advertisement and platform 140 provider receives a fee from the advertiser. The received advertising fees can be used to make additional profits when the platform provider is already making a profit from the difference in fees received from LEC 130 and the fee it pays to international carriers 150. In another embodiment, the advertising fees offset any fees the platform 140 provider would have to pay to international carriers 150. In this embodiment, platform 140 can provide free international calling instead of charging a fee to end users 110. In another embodiment, the advertising is played by the platform to either end user 110, receiving user 160, or both end user 110 and receiving user 160. In still another embodiment, advertising is only played when the termination fee of international carriers 150 is higher than or equal to a fee received by a provider of platform 140 from LEC 130.

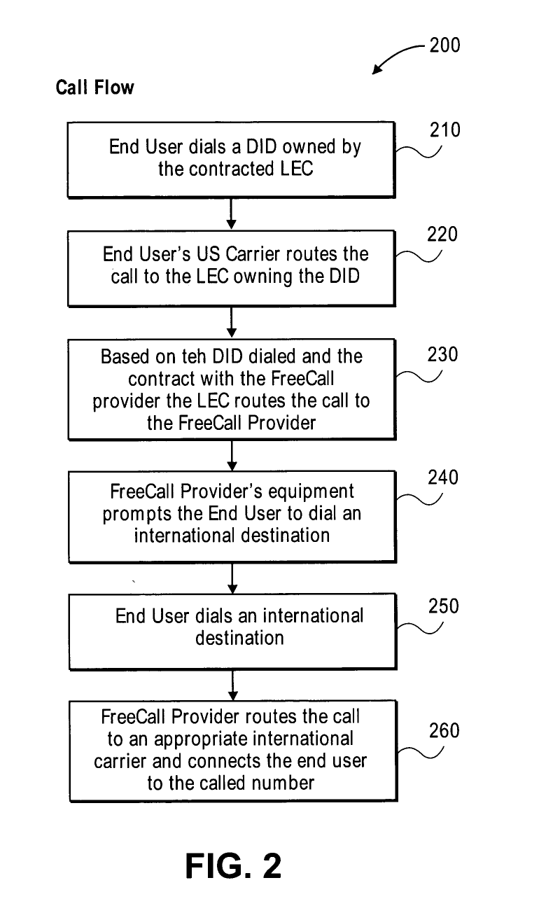

FIG. 2 illustrates a call process of an embodiment. Process 200 begins with block 210 where an end user (e.g., end user 110) places a call with a direct inward dialing (DID) service owned by the contracted and selected LEC (e.g., LEC 130). Next in block 220 the end user's U.S. carrier routes the call to the LEC owning the DID. In block 230, based on the DID dialed and the contract with the “free call” provider (e.g., platform 140 provider) the LEC (e.g., LEC 130) routes the call to the free call provider. In block 240 the free call provider's equipment prompts the end user to dial an international destination. In block 250 the end user enters the desired international destination number. And, in block 260 the free call provider (e.g., platform 140) routes the call to an appropriate and selected international carrier (e.g., international carrier 150) and connects the end user 110 to the receiving user 160.

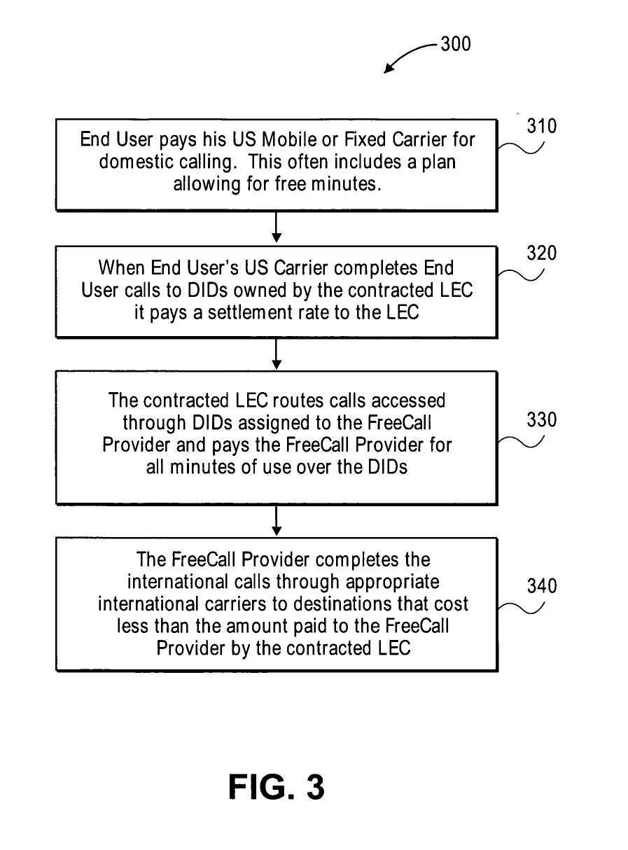

FIG. 3 illustrates an exemplary block diagram of a process or method 300 of an embodiment showing the payment flow of fees. In block 310 the end user pays their U.S. mobile or fixed land based carrier (U.S. carrier) for domestic calling, which can include a plan for free calling minutes. In block 320 after the end user's U.S. carrier completes a call made to a DID owned by a contracted LEC, the U.S. carrier pays a settlement rate to the contracted LEC. In block 330 the contracted LEC routes calls accessed through the DID's assigned to a free call provider (e.g., platform 140 provider) and pays the free call provider for all minutes of use over the DIDs. And, in block 340 the free call provider completes the international calls through appropriate international carriers to destinations where the international carriers are selected when the international carriers cost less than the amount paid to the free call provider by the contracted LEC.

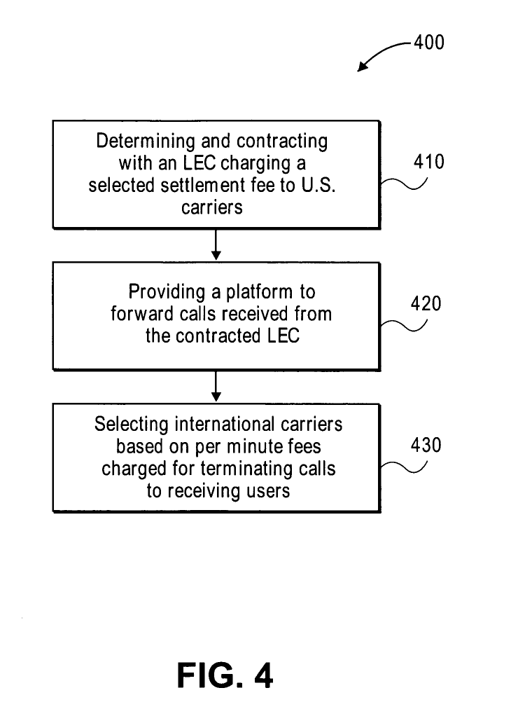

FIG. 4 illustrates process or method 400 for an embodiment where LECs and international carriers are selected based on fees. In block 410, LEC's are queried and contracted with for appropriately charging settlement fees to U.S carriers. In block 420 a platform (e.g., platform 140) is provided to forward calls from the contracted LEC. In block 430 international carriers are selected based on per minute fees charged for terminating calls to receiving users. In one embodiment, the international carriers are selected as long as their terminating fees are less than a fee shared with the platform provider from the selected and contracted LEC. In this embodiment, since the fee paid to the international carriers is less than the fee received from the contracted LEC, the platform provider can profit from providing “free calls” to end users.

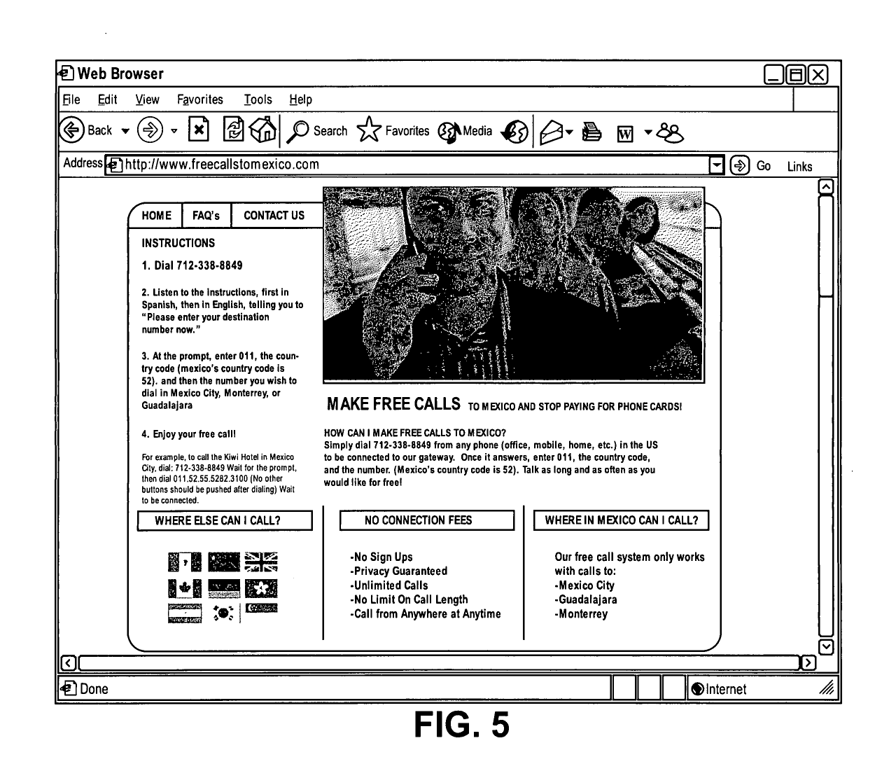

FIG. 5 illustrates a screen shot of an embodiment of the invention. As illustrated, the web page instructs end users to call a specific number provided for making “free calls” to international destinations. In this exemplary web page, the end users can make free calls to specific cities in Mexico by dialing a U.S. telephone number associated with a platform (e.g., platform 140) that is contracted with a selected LEC (e.g., LEC 130).

In one embodiment the specific number to dial for making free or reduced rate international calls is located in the 712 (i.e., Iowa) area code. In one embodiment a profit is made by the free call provider by having a low cost call terminated below the amount paid to it by the selected and contracted LEC, where the difference in fees is received by the free call provider as a profit. In one embodiment LEC receives monies from the Universal Service Fund for maintenance and improvements to those plants, in addition to subsidizing user fees for local residents. The cost basis to provide service in rural communities is dramatically lowered based on received subsidies.

Embodiments of the present disclosure described herein may be implemented in circuitry, which includes hardwired circuitry, digital circuitry, analog circuitry, programmable circuitry, and so forth. These embodiments may also be implemented in computer programs. Such computer programs may be coded in a high level procedural or object oriented programming language. The program(s), however, can be implemented in assembly or machine language if desired. The language may be compiled or interpreted. Additionally, these techniques may be used in a wide variety of networking environments. Such computer programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the disclosure may also be considered to be implemented as a machine-readable or machine recordable storage medium, configured for use with a processing system, where the storage medium so configured causes the processing system to operate in a specific and predefined manner to perform the functions described herein.

Thus, a method and system for providing toll free or reduced rate international telephone service have been described. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Accordingly, the specification and drawings are to be regarded in an illustrative rather than a restrictive sense.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

What is claimed is:

1. A system comprising:
a local exchange carrier that operates to receive telephone calls from a plurality of carriers;
a platform that operates to receive the telephone calls from the local exchange carrier; and
a plurality of selected international carriers to receive the telephone calls from the platform,
wherein the plurality of selected international carriers are selected so that termination fees of the plurality of selected international carriers are one of less than and equal to fees received by a provider of the platform from the local exchange carrier.

2. The system of claim 1, wherein a plurality of end users are not charged international telephone fees by calling a telephone number associated with the local exchange contractor.

3. The system of claim 2, wherein the plurality of end users make one of a local telephone call and a long distance telephone call to access a service through the telephone number, and the service operates to place an international telephone call.

4. The system of claim 2, wherein the platform plays an advertisement for the plurality of users.

5. The system of claim 4, wherein the provider of the platform receives advertisement fees.

6. The system of claim 4, wherein the advertisement is played when the termination fees of the plurality of selected international carriers are equal to fees received by the provider of the platform from the local exchange carrier.

7. The system of claim 1, wherein the local exchange contractor is contracted by the platform provider, and the local exchange contractor is selected by the provider of the platform based on settlement fees.

8. A method comprising:
selecting a local exchange contractor;
providing a platform to forward telephone calls received by the local exchange contractor; and
selecting a plurality of international carriers to receive the call from the platform,
wherein the plurality of international carriers are selected based on international termination fees being less than fees received by a platform provider from the local exchange carrier.

9. The method of claim 8, further comprising:
placing a call by an end user by calling a telephone number associated with the local exchange carrier;
entering an international telephone number by the end user through the platform; and
forwarding the call to one of the plurality of international carriers,
wherein a receiving user receives the call from the one of the plurality of international carriers.

10. The method of claim 9, wherein the end user placing the call makes one of a local domestic call and a long distance domestic call.

11. The method of claim 10, wherein the end user is charged by a domestic carrier for the one of the local domestic call and the long distance domestic call.

12. The method of claim 10, wherein the end user places the call during a time period when the call is free of charge, and an international call is made by the end user free of additional charges.

13. The method of claim 8, wherein the platform plays an advertisement for one of the end user, the receiving user, and both the end user and the receiving user.

14. The method of claim 13, wherein the provider of the platform receives advertisement fees.

15. The method of claim 13, wherein the advertisement is played when the termination fees of the plurality of selected international carriers are equal to fees received by the provider of the platform from the local exchange carrier.

16. The method of claim 8, wherein the local exchange contractor is selected by the provider of the platform based on settlement fees.

17. A method comprising:
placing a call to a telephone number associated with a selected local exchange carrier;
requesting an end user to enter an international telephone number by a platform;
forwarding the call to the international telephone number,
wherein the end user is not charged an international calling fee.

18. The method of claim 17, further comprising:
selecting a plurality of international carriers,
wherein the plurality of international carriers are selected based on international termination fees being less than fees received by a platform provider from the local exchange carrier.

19. The method of claim 17, wherein the end user placing the call makes one of a local domestic call and a long distance domestic call.

20. The method of claim 19, wherein the end user is charged by a domestic carrier for the one of the local domestic call and the long distance domestic call.

21. The method of claim 19, wherein the end user places the call during a time period when the call is free of charge, and an international call is made by the end user free of international calling charges.

22. The method of claim 17, wherein the platform plays an advertisement for one of the end user, a receiving user, and both the end user and the receiving user.

23. The method of claim 22, wherein a provider of the platform receives advertisement fees.

24. The method of claim 18, wherein the advertisement is played when the termination fees of the plurality of selected international carriers are equal to fees received by the provider of the platform from the local exchange carrier.

25. The method of claim 18, wherein the local exchange contractor is selected by the provider of the platform based on settlement fees.

26. A system comprising:
a first device used by a first user to place a telephone call through a domestic carrier;
a local exchange carrier that operates to receive the telephone call from the domestic carrier; and
a platform that operates to place an international telephone call to connect the first device to a second device used by a second user;
wherein a plurality of selected international carriers are selected so that termination fees of the plurality of selected international carriers are one of less than and equal to fees received by a provider of the platform from the local exchange carrier.

27. The system of claim 26, wherein the first user is not charged international calling fees.

28. The system of claim 26, wherein the first user makes one of a local telephone call and a long distance telephone call to access a service through the telephone number.

29. The system of claim 26, wherein the platform plays an advertisement for one of the first user, the second user, and both the first user and the second user.

30. The system of claim 29, wherein the provider of the platform receives advertisement fees.

31. The system of claim 30, wherein the advertisement is played when the termination fees of the plurality of selected international carriers are equal to fees received by the provider of the platform from the local exchange carrier.

32. The system of claim 26, wherein the local exchange contractor is selected by the provider of the platform based on settlement fees.
